(19) United States
(12) Patent Application Publication
(10) Pub. No.: US 2007/0217102 A1
(43) Pub. Date: Sep. 20, 2007

(54) Interface circuit for a functional unit of a multi-chip system

(75) Inventor: Ping-Yang Chuang, Taipei City (TW)

Correspondence Address: RABIN & Berdo, PC, 1101 14TH STREET, NW, SUITE 500, WASHINGTON, DC, 20005, US

(73) Assignees: A-DATA TECHNOLOGY CO., LTD., Taipei (TW); PING-YANG CHUANG, Taipei City (TW)

(21) Appl. No.: 11/643,892

(22) Filed: Dec. 22, 2006

(30) Foreign Application Priority Data
Mar. 17, 2006 (TW) 095204480

(51) Int. Cl. H02H 9/00

(52) U.S. Cl. 361/56

(57) ABSTRACT

An interface circuit connected between the functional unit and the output/input bus in a multi-chip system is disclosed. One characteristic of the present invention is that the positive voltage protecting diode located between the independent power of the functional unit and the output/input bus in the functional circuit is not required. Therefore, the signal on the output/input bus will not be distorted due to the low resistance load caused by shutting down the independent power of the functional unit. Another characteristic of the present invention is that the negative voltage protecting diode located between the output/input bus and the grounding in the functional circuit is changed to a stable voltage Zener diode. Therefore, the high voltage static electricity is guided into the grounding via the Zener diode so that the goals of anti-static electricity and protecting the functional unit are achieved.

### BACKGROUND OF THE INVENTION

1. Field of the Invention

The present invention relates to a multi-chip system. In particular, this invention relates to an interface circuit that is connected between a functional unit and an output/input bus in a multi-chip system.

2. Description of the Related Art

System on chip (SoC) has been a mainstream method of manufacturing in the semiconductor industry since 2000. SoC is complex and requires a lengthy design period. In order to reduce the product's cost and shorten the developing period, system in package (SiP) or multi-chip package (MCP) systems are commonly used in SoC. SiP includes more than two chips, and passive elements, such as capacitors, resistors, connectors, antennas etc, in a single package. There are a variety of SiP types. According to its disposition method, SiP can be disposed in a plane, or stacked so as to reduce the dimensions of the package. The chips in the SiP are connected together by a wire-bonding method, a flip chip method, or both.

Because cell pones need to have the functions of reading a program code, baseband application buffers and multi-media storage, three kinds of chip, NOR Flash, NAND Flash, and Pseudo SDRAM, are used in cell phones. Therefore, SiP is usually applied to the cell phone's memory chips, and memory cards. Furthermore, memory chips have similar dimensions and methods of wire-bonding, standard electrical characteristics, and are usually supplied by a number of different suppliers. SiP is the most suitable as a cell phone's memory chips and memory cards. The present invention uses multi-chip memory cards as an example to illustrate the content of the present invention, and uses a multi-chip system to represent the current SiP, or a similar package having a plurality of chips.

Multi-chip systems also have many drawbacks. The main problem is that the chips are supplied by different suppliers. The operating voltages are different from each other so that a complex power control circuit is required. It also suffers from high power consumption and circuit noise. FIG. 1A is a schematic diagram of the interior of a multi-chip memory card of the prior art. The multi-chip memory card 1 shown in FIG. 1A is a memory card that can be plugged into a portable electronic device, such as a cell phone, a digital still camera, an MP3 player, or a PDA, to store multi-media files. It can also be plugged into the USB port of a computer or a laptop. As shown in FIG. 1A, the multi-chip memory card 1 includes an output/input bus 10 connected with the output/input interface of a portable electronic device, and a functional bus 20 connected with the USB port 22 of a computer. Accessing the memory 32 of the multi-chip memory card 1 is controlled via a memory controller 30. The output/input of the USB port 22 of the computer is controlled by a controller 40 via the functional bus 20. Access between the portable electronic device, or the computer and the memory 32, is executed via the output/input bus 10.

The structure shown in FIG. 1A can also be used for a card reader 1 having multiple interfaces. The memory 32 and the memory controller 30 in FIG. 1A is a MicroSD card (the block with a dash line in FIG. 1A) that can be plugged into the card reader 1. The output/input interface 12 is an SD interface. Through this design, the MicroSD card in the card reader 1 can be plugged into a portable electronic device with an SD interface, such as a cell phone, a digital still camera, an MP3 player, or a PDA, etc. The MicroSD interface is therefore not required. Alternatively, the card reader 1 can also be plugged into the USB port of a computer or a laptop via the USB port 22.

From the structure shown in FIG. 1A, the interior circuit of a similar multi-chip system can also be abstractly represented as in FIG. 1B. As shown in FIG. 1B, the multi-chip system includes a common control unit 300, and at least one functional unit (FIG. 1B shows two functional units 400, 410). The multi-chip system can include more functional units. In order to simplify the figure, FIG. 1B only shows two functional units. In a multi-chip memory card 1, the common control unit 300 is the memory controller 30. The function of the common control unit 300 is the same as that of the central processor of the multi-chip system: for communicating and controlling the functional units 400, 410 to complete their function. The functional units 400, 410 perform the same functions the controller 40 of the multi-chip memory card 1. Each of the functional units 400, 410 has functional buses 200, 210 and functional interfaces 202, 212 (such as a USB port 22). The common control unit 300 and the functional units 400, 410 are connected with the output/input bus 100. Data exchange is implemented via the output/input bus 100, and control signals 104 are also transmitted via the output/input bus 100. The output/input bus 100 is connected with the output/input interface 102 of the multi-chip system. When the multi-chip system in FIG. 1B is a memory card as shown in FIG. 1A, the memory chip (the block with a dash line in FIG. 1A) is included. The named “unit” includes the chip and the related passive elements.

Furthermore, the common control unit 300, and the functional units 400, 410 have their own operating powers V1, V2, V3. For example, when the multi-chip system is linked with an electronic device, the operating powers V1, V2, V3 are the power provided from the electronic device via the output/input interface or functional interface. The power is converted into a proper voltage via a converting circuit (not shown in the figure) and is provided to each of the units. Because part of the functional units needs to operate, the power provided via the above method has a redundant load (meaning that the provided power exceeds the required power). Power consumption increases. In order to overcome the above problem, the structure in FIG. 1C is disclosed (in order to simplify the diagram, the control signals are omitted). The buffer switches 500, 510 are located between the functional units 400, 410 and the output/input bus 100. When only the functional unit 410 needs to operate, the power provided for the functional unit 400 ceases (an X is marked around V2) and the buffer switch 500 is controlled to separate the functional unit 400 and the output/input bus 100 (the purpose of the separating will be explained later). However, the buffer switches 500 and 510 still need to provide the power V4 continually. The load for the power just decreases slightly and the cost increases due to the buffer switch being added. Furthermore, the buffer switch substantially increases the dimensions and the cost of the circuit layout of the multi-chip system. Moreover, when the buffer switch is connected with the output/input bus with a high bit number and a high transmitting rate, the stability of the buffer switch is inadequate.

When the structure in FIG. 1C does not include the buffer switches 500 and 510, the signal on the output/input bus is distorted. FIG. 2a shows a waveform diagram of the signal on the output/input bus of the multi-chip system of the prior art in a normal condition. In the normal condition (all units are supplied with power, or the buffer switch is added), the level of the signal is higher than the threshold level TG. When the buffer switch is removed and the power provided for the non-operating unit ceases, the signal waveform is shown in FIG. 2B. The level of the signal is lower than the threshold level TG, and the system is abnormal.

The cause of the signal distortion is shown in FIG. 1D. In order to simplify the diagram, only the common control unit 300 and the functional unit 40 (when power has ceased) are shown. The core logics of the common control unit 300 and the functional unit 400 are also simplified into two blocks 304 and 404. One bus line 106 of the output/input bus 100 is used as an example. There are positive voltage protecting diodes 306, 406 and negative voltage protecting diodes 308, 408 disposed on the interface between the core logics 304, 304 of the common control unit 300 and the functional unit 400 and the bus line 106. Diodes 306, 308 are inversely connected between the power V1 and the grounding in serial. Similarly, diodes 406, 408 are inversely connected between the power V2 and the grounding in serial. The diode disposed on the interface of the output/input bus is used to protect the common control unit and the functional unit from being damaged by high voltage static electricity. When the high voltage static electricity occurs around the functional unit 400, the high voltage static electricity is guided into the grounding along the dash line in the figure, via the diode 406 and the capacitor 402. When the high voltage static electricity occurs around the common control unit 300, the high voltage static electricity is guided into the grounding via the diode 306 and the capacitor 302. However, when the V2 is not provided, the dash line in the figure means that a current path forms a low resistance load on the output/input bus 100. Therefore, the level of the signal in FIG. 2A is pulled to the level shown in FIG. 2B. The signal waveform is distorted and the accuracy of the data transmission is affected.

### SUMMARY OF THE INVENTION

One particular aspect of the present invention is to provide an interface circuit that is connected between the functional unit and the output/input bus in a multi-chip system. The multi-chip system utilizing the interface circuit has the following effects. (1) Each of the functional units in the multi-chip system can be supplied with power independently to reduce redundant power. (2) The buffer switch is not required to separate the functional unit and the output/input bus so that costs are decreased. (3) The signal on the output/input bus will not be distorted due to the ceasing of the power supply to one functional unit. (4) The core logic that protects the functional unit is not damaged by the high voltage static electricity.

One characteristic of the present invention is that the positive voltage protecting diode located between the independent power of the functional unit and the output/input bus in the functional circuit can be omitted. Therefore, the signal on the output/input bus will not be distorted due to the low resistance load caused by shutting down the independent power of the functional unit.

Another characteristic of the present invention is that the negative voltage protecting diode located between the output/input bus and the grounding in the functional circuit is changed to a stable voltage Zener diode. Therefore, the high voltage static electricity is guided into grounding via the Zener diode so that the goals of anti-static electricity and protecting the functional unit are achieved.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1A is a schematic diagram of the multi-chip memory card of the prior art;

FIG. 1B is a schematic diagram of the circuit of the multi-chip system of the prior art;

FIG. 1C is a schematic diagram of the circuit of another multi-chip system of the prior art;

FIG. 1D is a schematic diagram of the low-resistance path caused by the multi-chip system that has a functional unit without a power supply of the prior art;

FIG. 2A is a signal waveform diagram of the output/input bus of the multi-chip system under normal conditions of the prior art;

FIG. 2B is a signal waveform diagram of the output/input bus of the multi-chip system that has a functional unit without a power supply of the prior art;

FIG. 2C is a signal waveform diagram of the output/input bus of the multi-chip system that has a functional unit without a power supply of the present invention;

FIG. 3A is a schematic diagram of the circuit of the multi-chip system of the preferred embodiment of the present invention;

FIG. 3B is a schematic diagram of the interface circuit of the common control unit and the functional unit of the first embodiment of the present invention; and

FIG. 3C is a schematic diagram of the interface circuit of the common control unit and the functional unit of the second embodiment of the present invention.

### DETAILED DESCRIPTION OF THE PREFERRED EMBODIMENTS

The present invention provides an interface circuit that is connected between the functional unit and the output/input bus in a multi-chip system. The present invention can be applied to the multi-chip system that is packaged by the SiP, MCP, or other similar packages that include multiple chips. Currently, the multi-chip memory card can be used in cell phones, digital still cameras, MP3 players, PDAs, computers, and laptops. The multi-chip memory card is suitable for any formats, such as MMC, SD, Micro-SD, etc. However, the present invention is not limited to the above description. For example, the present invention can also be a card reader that combines the common control unit or the functional unit with the multi-chip system via a card-plugging method. In order to simplify the illustration, the present invention does not focus on whether the common control unit or the functional unit is combined with the multi-chip system via a card-plugging method or not.

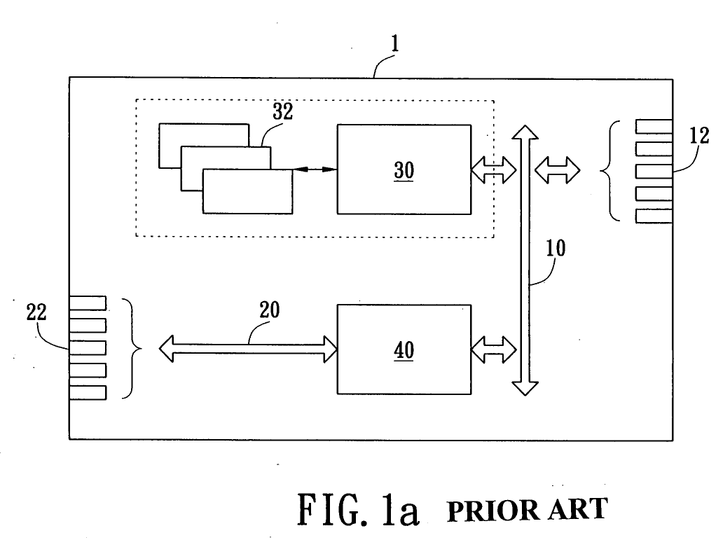

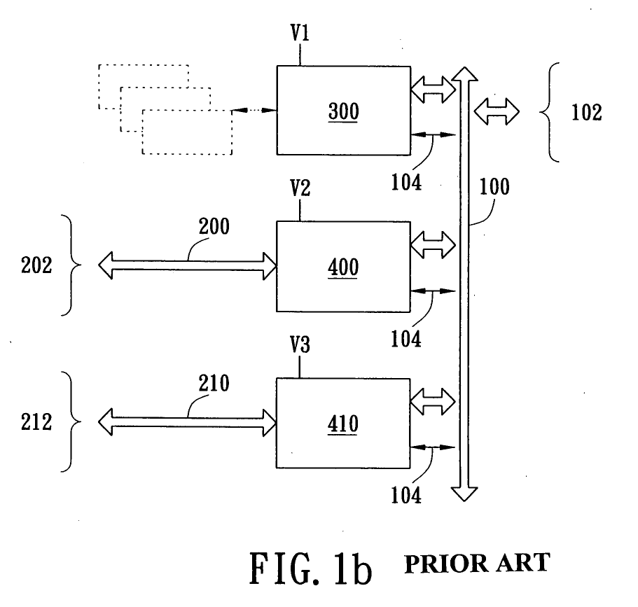

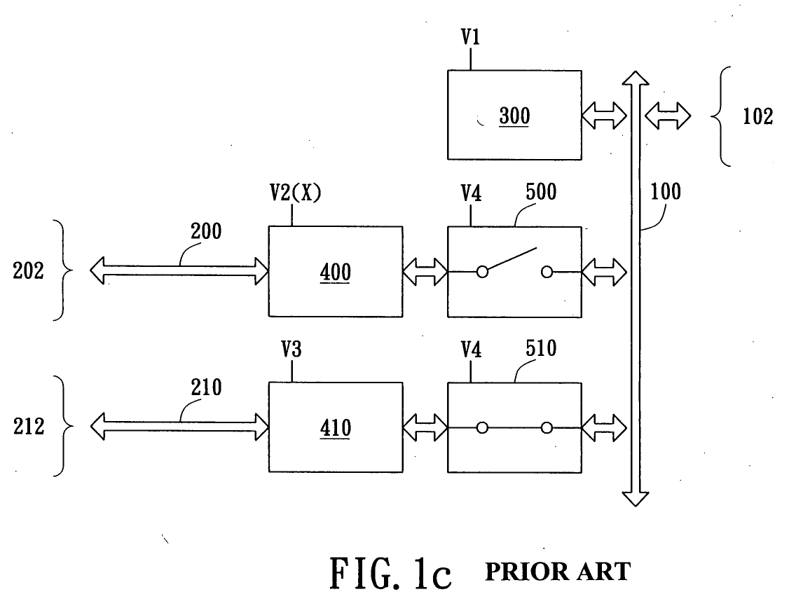

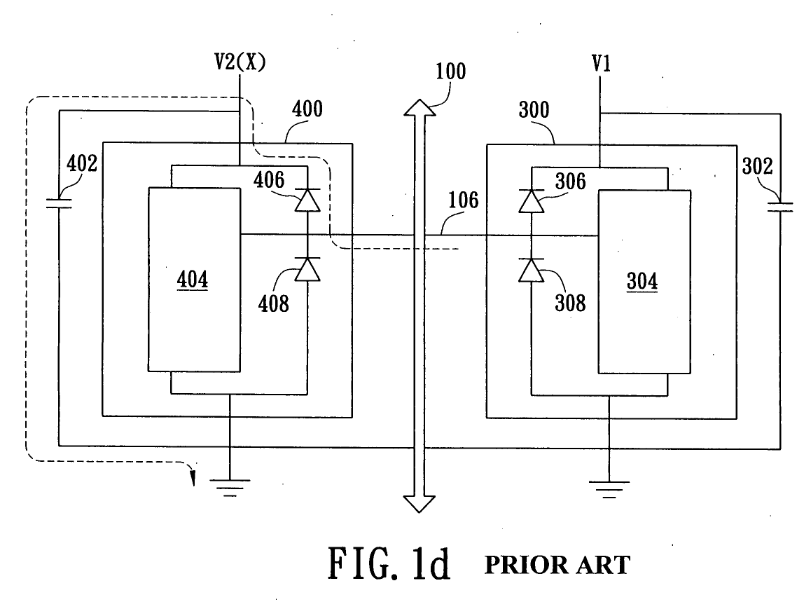

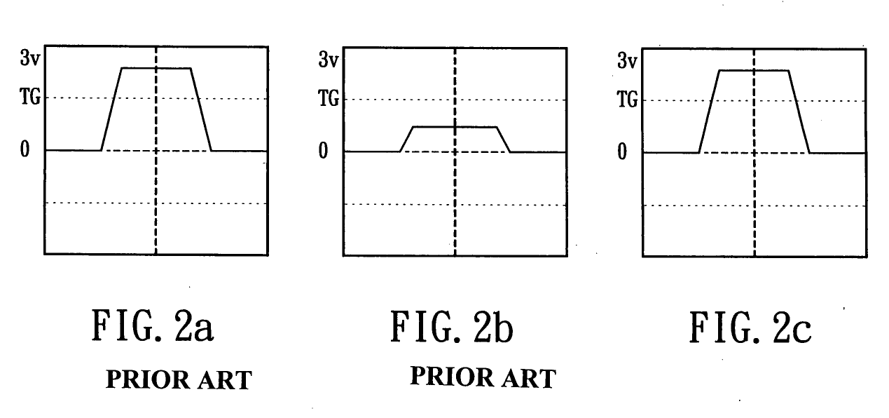

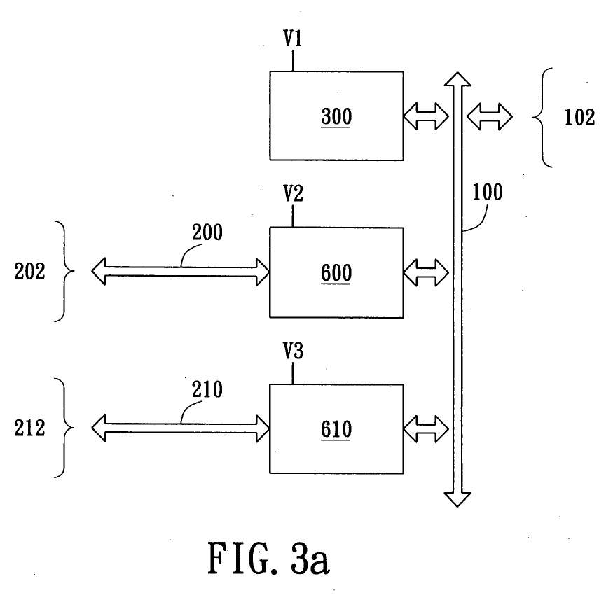

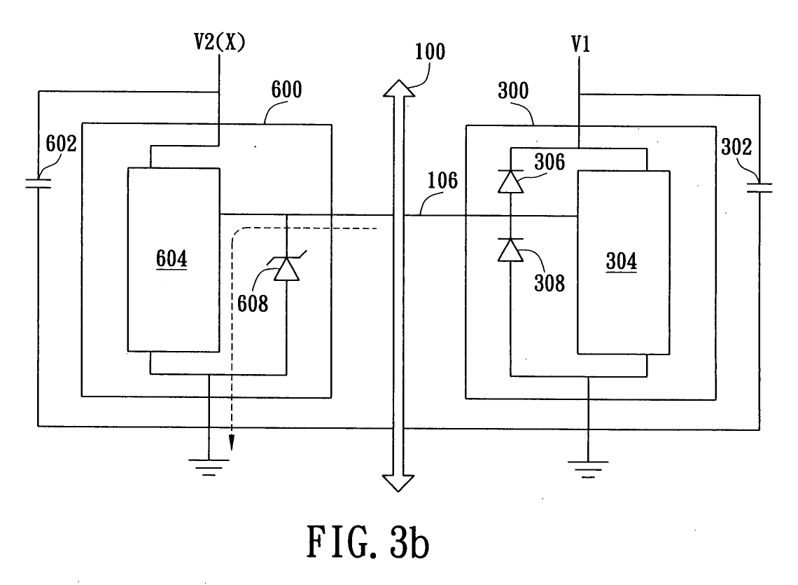

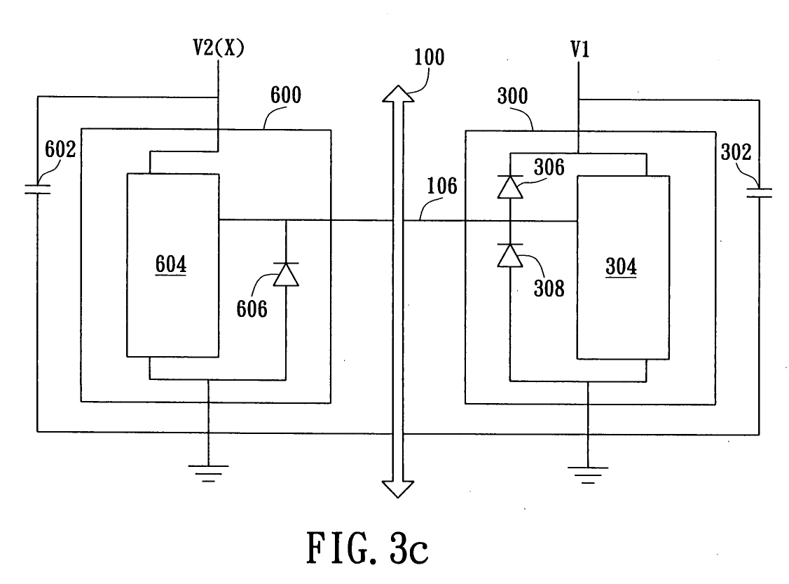

FIG. 3A shows a schematic diagram of the circuit of the multi-chip system of the preferred embodiment of the present invention. The multi-chip system at least includes a common control unit 300, and at least one functional unit (FIG. 3A shows two functional units 600, 610). The common control unit 300 and the functional units 600, 610 are supplied by the powers V1, V2, V3 that are independent of each other. The power V1 is always supplied to the common control unit 300. Depending on whether the functional units 600, 610 are being used or not, the powers V2, V3 of the functional units 600, 610 are turned on or off. The detailed contents refer to the illustration of FIG. 1B.

FIG. 3B shows a schematic diagram of the interface circuit of the common control unit 300 and the functional unit 600 of the multi-chip system of FIG. 3A. Comparing FIG. 3B with FIG. 1D, the common control unit 300 has an interface circuit structure that is the same as the prior art. The functional unit 600 is also the same as the prior art, and includes a core logic 604 and a capacitor 602 etc. However, in the interface that is connected with the output/input bus 100, a Zener diode 608 with a proper breakdown voltage replaces two diodes that are connected in serial. The cathode of the Zener diode 608 is connected with the bus line 106, and the anode of the Zener diode 608 is connected with the grounding. The Zener diode 608 protects the core logic 604 of the functional unit 600 and prevents the core logic 604 of the functional unit 600 from being damaged by high voltage static electricity. When static electricity that is larger than the breakdown voltage of the Zener diode 608 occurs, the Zener diode is inversely passed through. The static electricity is guided into the grounding via the dash line shown in the figure. The core logic 604 is not damaged.

When the functional unit 600 is not being used, the power V2 is turned off to reduce power consumption. The current path from the bus line 106 to the power V2 of the prior art is removed in the present invention. Furthermore, when the breakdown voltage of the Zener diode 608 is larger than the signal level of the output/input bus 100, the Zener diode is not inversely passed through. Therefore, the problem of forming a low resistance load along the dash line in the figure is prevented. The signal of the output/input bus 100 is not distorted due to the power of a function unit being turned off.

Reference is made to FIG. 3C. The Zener diode 608 can also be replaced by a general diode 606. In this embodiment, the signal of output/input bus 100 is also not distorted due to turning off the power of a function unit. When high voltage static electricity occurs in the output/input bus 100, the high voltage static electricity is guided into the grounding along the diode 306 of the common control unit 300, and the capacitor 302 so that the protection function is achieved.

In FIGS. 3B and 3C, the interface circuit of the common control unit 300 is the same as the prior art. However, the interface circuit of the present invention can also be implemented in the common control unit 300. Because the power V1 is always supplied to the common control unit 300, the interface circuit of the present invention in the common control unit 300 only provides the static electricity protection function.

In this embodiment, because none of the functional units have an independent power supply and can all be turned off depending on the requirements of a multi-chip system, the present invention can be applied to part of the functional units (when the functional unit has an independent power supply and can be turned off depending on requirements), or all of the functional units (when all functional units have an independent power supply and can be turned off depending on requirements). When the embodiment shown in FIG. 3C (using a general diode) is implemented to all functional units, the common control unit has to have a positive voltage protection diode or other such similar protective structures to guide the high voltage static electricity into the grounding via the positive voltage protection diode or other similar protective structures of the common control unit 300 when the high voltage static electricity occurs in the output/input bus.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An interface circuit for a functional unit of a multi-chip system, wherein the multi-chip system includes at least one common control unit, at least one functional unit, and an output/input bus connected with the common control unit and the functional unit, the multi-chip system individually drives the common control unit and the functional unit via a plurality of independent powers, the power of the functional unit can be turned on or off according to requirements, the interface circuit of the functional unit is located between the output/input bus and the functional unit, the interface circuit comprising:
a Zener diode, wherein the anode of the Zener diode is connected with a grounding of the multi-chip system, the cathode of the Zener diode is connected with a bus line of the output/input bus, and the Zener diode has a proper breakdown voltage.

2. The interface circuit for a functional unit of a multi-chip system as claimed in claim 1, wherein the breakdown voltage is at least larger than the signal level of the output/input bus.

3. An interface circuit for a functional unit of a multi-chip system, wherein the multi-chip system includes at least one common control unit, at least one functional unit, and an output/input bus connected with the common control unit and the functional unit, the multi-chip system individually drives the common control unit and the functional unit via a plurality of independent powers, the power of the functional unit is turned on or off according to requirements, the common control unit has a proper static electricity protective structure, the interface circuit of the functional unit is located between the output/input bus and the functional unit, the interface circuit comprising:
a diode, wherein the anode of the diode is connected with a grounding of the multi-chip system, and the cathode of the diode is connected with a bus line of the output/input bus.

4. The interface circuit for a functional unit of a multi-chip system as claimed in claim 1, wherein at least one of the common control units and the functional units are combined with the multi-chip system via a card-plugging method.

5. The interface circuit for a functional unit of a multi-chip system as claimed in claim 3, wherein at least one of the common control units and the functional units are combined with the multi-chip system via a card-plugging method.
